(19) United States
(12) Patent Application Publication
(10) Pub. No.: US 2009/0137770 A1
(43) Pub. Date: May 28, 2009

(54) POLYMIDE OPTICAL COMPENSATION FILMS

(75) Inventors: Chyi-Ming Leu, Taichung County (TW); Chi-Fu Tseng, Taipei City (TW)

Correspondence Address: THOMAS, KAYDEN, HORSTEMEYER & RISLEY, LLP, 600 GALLERIA PARKWAY, S.E., STE 1500, ATLANTA, GA, 30339-5994, US

(73) Assignee: INDUSTRIAL TECHNOLOGY RESEARCH INSTITUTE, Hsinchu (TW)

(21) Appl. No.: 12/036,359

(22) Filed: Feb. 25, 2008

(30) Foreign Application Priority Data
Nov. 27, 2007 (TW) 96144951

(51) Int. Cl. C08G 73/10

(52) U.S. Cl. 528/353

(57) ABSTRACT

A polyimide optical compensation film is provided. The polyimide optical compensation film has the formula:

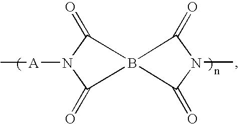

wherein when A is cycloaliphatic, B is aromatic or cycloaliphatic, when A is aromatic, B is cycloaliphatic, and n is an integer greater than 1. The optical compensation film has in-plane retardation (R0) and thickness direction retardation (Rth).

### BACKGROUND OF THE INVENTION

1. Field of the Invention

The invention relates to an optical compensation film, and in particular to a polyimide optical compensation film with in-plane retardation (R0) and thickness direction retardation (Rth).

2. Description of the Related Art

Liquid crystal displays with light weight, thin profiles, low power consumption and high resolution are widely used in commercial electronic products, such as, digital watches, calculators, cell phones, notebooks, desktop computers and large-scale LCD TVs. The shading effect of LCDs is depended on birefringence and rotatability of liquid crystal molecules. With increasing in sizes and use of LCDs, viewability from various angles is an important property such that it is essential to achieve wide-viewing-angle performance. Currently, the simple way to increase viewing angle is to directly add: an optical compensation film without fabrication alteration. However, proper thickness, birefringence and high light-transmittance thereof are required.

With various optical properties, the compensation film can be divided into uniaxial film comprising A-plate and C-plate and biaxial film. The refractive index of the A-plate film is ny=nz≠nx, wherein x axis is parallel to the film. The refractive index of the C-plate film is ny=nx≠nz, wherein z axis is perpendicular to the film. The refractive indexes along x, y and z axes of the biaxial film are different. According to optical symmetrical relationship among liquid crystal molecules in a liquid crystal box, it is required that a combination of the A-plate film and a negative C-plate film (ny=nx>nz) or the biaxial film is used to increase viewing angle. The A-plate film can be prepared by single-axis extension of PC, PES, PET, PVA or MCOC. The negative C-plate and biaxial films can be prepared by two single-axis extension along various directions, respectively. However, it is difficult to control such fabrication.

In U.S. Pat. No. 7,054,049, Japan Nitto Denko Corporation discloses coating a polyimide solution on a TAC film and then having a single-axis extension or coating a polyimide solution on an extended TAC film, to prepare a wide-viewing-angle film. Additionally, in US 2006/0109403, PU resin is coated on a TAC film to increase adhesion between the TAC film and polyimide. Single-axis extension is then performed. Thus, it is obvious that the current optical compensation film is composed of two optical films, that is, a polyimide film and a TAC film.

### BRIEF SUMMARY OF THE INVENTION

The invention provides a polyimide optical compensation film having formula:

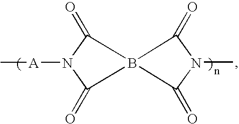

wherein when A is cycloaliphatic, B is aromatic or cycloaliphatic, when A is aromatic, B is cycloaliphatic, and n is an integer greater than 1. The optical compensation film has in-plane retardation (R0) and thickness direction retardation (Rth).

The polyimide optical compensation film may be formed by: addition of one cycloaliphatic diamine and one aromatic dianhydride; one cycloaliphatic diamine, one aliphatic dianhydride and one aromatic dianhydride with various ratios; one aromatic diamine and one cycloaliphatic dianhydride; and one cycloaliphatic diamine and one aromatic diamine with various ratios and one cycloaliphatic dianhydride.

The polyimide is synthesized by one cycloaliphatic diamine monomer and one aromatic dianhydride monomer or one aromatic diamine monomer and one cycloaliphatic dianhydride monomer. After single-axis extension, a single-layer polyimide film capable of retardation compensation is formed, suitable for use in wide-viewing-angle LCDs. Additionally, the polyimide is light due to addition of the cycloaliphatic components without absorption of visible light (400-700 nm) and such industrial raw material is easily acquired.

The hardness of the polyimide film is increased by the merged cycloaliphatic structure. Thus, a solid polyimide optical compensation film with negative birefringence and negative c-plate retardation is obtained. Also, the cycloaliphatic-containing polyimide possesses high light-transmittance within 400-700 nm and high solubility. After single-axis extension, an optical compensation film with in-plane retardation (R0) and thickness direction retardation (Rth) is thus formed.

A detailed description is given in the following embodiments.

### DETAILED DESCRIPTION OF THE INVENTION

The following description is of the best-contemplated mode of carrying out the invention. This description is made for the purpose of illustrating the general principles of the invention and should not be taken in a limiting sense. The scope of the invention is best determined by reference to the appended claims.

One embodiment of the invention provides a polyimide optical compensation film having formula:

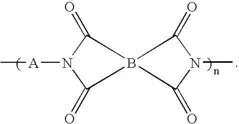

In the formula, when A is cycloaliphatic, B may be aromatic or cycloaliphatic. When A is aromatic, B may be cycloaliphatic. For example, when A comprises

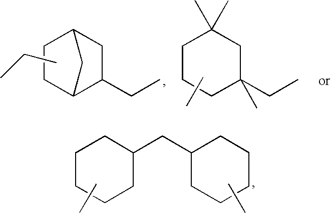

B may comprise

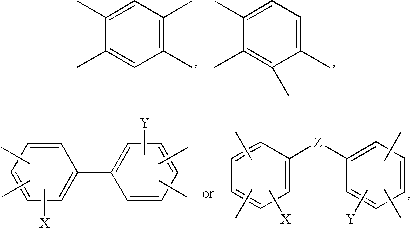

wherein X and Y may comprise —H, —CH₃, —CF₃, —OH, —OR, —Br, —Cl or -I, and Z may comprise —O—, —CH₂—, —C(CH₃)₂—, —Ar—O—Ar—, —Ar—CH₂—Ar—, —O—Ar—C(CH₃)₂—Ar—O—, —O—Ar—Ar—O—, 13 O—Ar—C(CF₃)₂—Ar—O— or —Ar—C(CH₃)₂—Ar—. B may also comprise

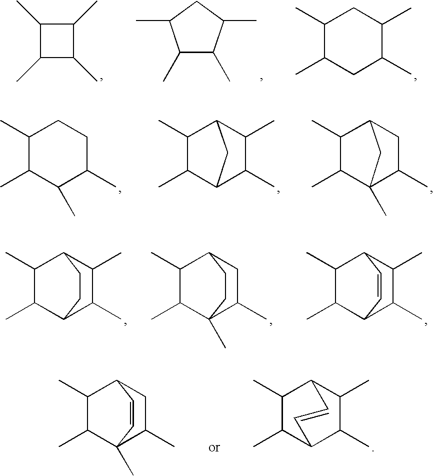

When A comprises

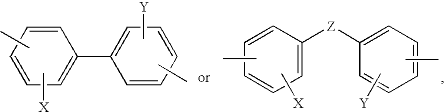

wherein X and Y may comprise —H, —CH₃, —CF₃, —OH, —OR, —Br, —Cl or —I, and Z may comprise —O—, —CH₂—, —C(CH₃)₂—, —Ar—O—Ar—, —Ar—CH₂—Ar—, —O—Ar—C(CH₃)₂—Ar—O—, —Ar—O—Ar—C(CH₃)₂—Ar—O—Ar—, —O—Ar—Ar—O—, —O—Ar—C(CF₃)₂—Ar—O— or —Ar—C(CH₃)₂—Ar—, B may comprise

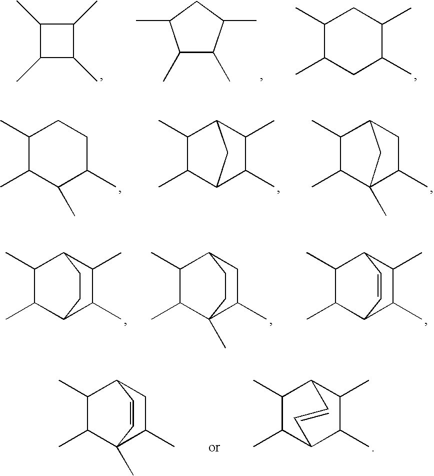

The n value is an integer greater than 1.

Specifically, the polyimide optical compensation film has both, in-plane retardation (R0) of about 20-450 nm and thickness direction retardation (Rth) of about 40-900 nm. The polyimide optical compensation film has thickness of about 5-30 μm.

The polyimide optical compensation film may be formed by: addition of one cycloaliphatic diamine and one aromatic dianhydride; one cycloaliphatic diamine, one aliphatic dianhydride and one aromatic dianhydride with various ratios; one aromatic diamine and one cycloaliphatic dianhydride; and one cycloaliphatic diamine and one aromatic diamine with various ratios and one cycloaliphatic dianhydride.

The polyimide is synthesized by one cycloa liphatic diamine monomer and one aromatic dianhydride monomer or one aromatic diamine monomer and one cycloaliphatic dianhydride monomer. After single-axis extension, a single-layer polyimide film capable of retardation compensation is formed, suitable for use in wide-viewing-angle LCDs. Additionally, the polyimide is light due to addition of the cycloaliphatic components without absorption of visible light (400-700 nm) and such industrial raw material is easily acquired.

The hardness of the polyimide film is increased by the merged cycloaliphatic structure. Thus, a solid polyimide optical compensation film with negative birefringence and negative c-plate retardation is obtained. Also, the cycloaliphatic-containing polyimide possesses high light-transmittance within 400-700 nm and high solubility. After single-axis extension, an optical compensation film with in-plane retardation (R0) and thickness direction retardation (Rth) is thus formed.

The polyimide is synthesized by polycondensation, which is disclosed as follows. One method is that diamine monomer and dianhydride monomer are reacted in a polar solvent to form poly(amic acid) (PAA) (precursor of polyimide). PAA is then thermally imidized (300-400° C.) or chemically imidized to dehydrate to form polyimide. The other method is that diamine monomer and dianhydride monomer are reacted in a phenolic solvent (for example: m-cresol or Cl-phenol). After heating to reflux temperature, polyimide is prepared.

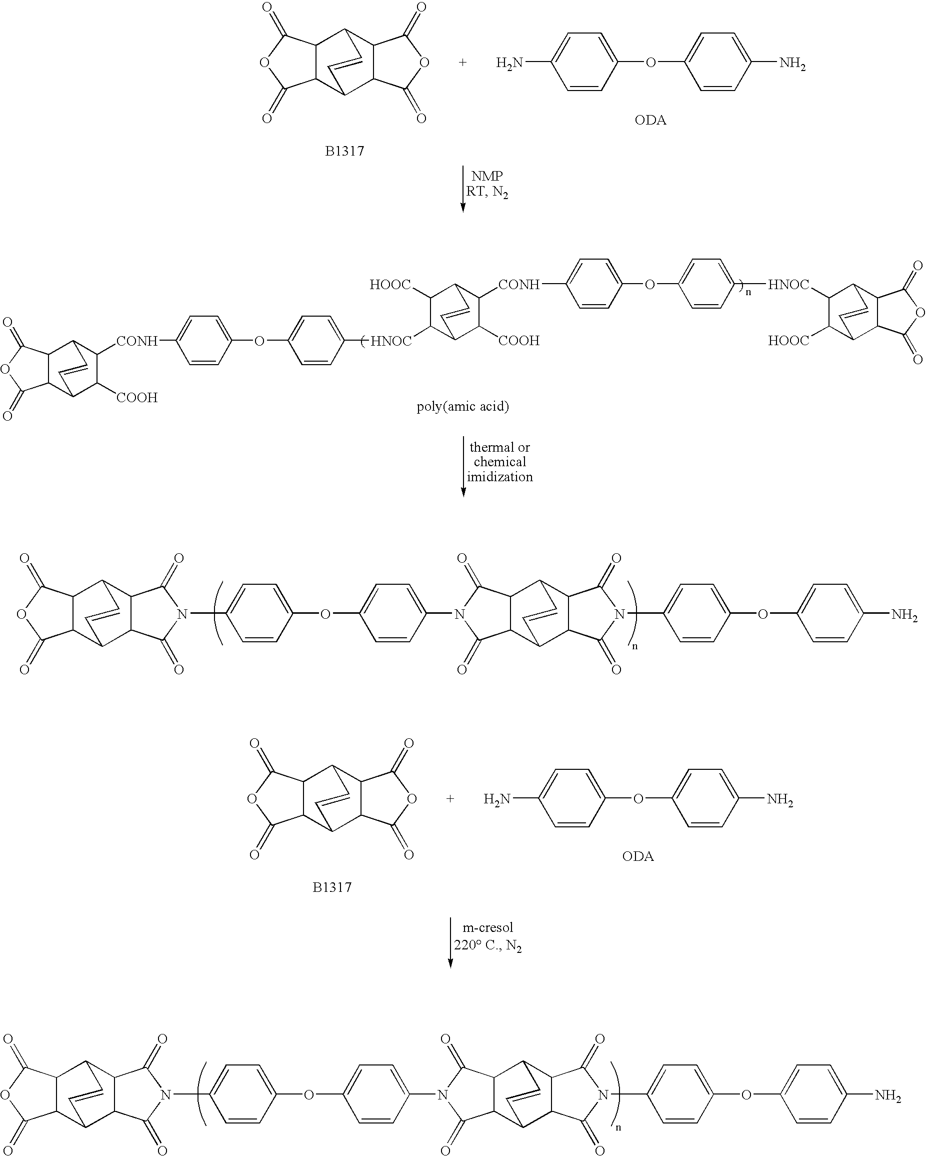

### EXAMPLE 1

### Preparation of B1317-BAPB-co-B1317-BAPPm (PI-BAB)

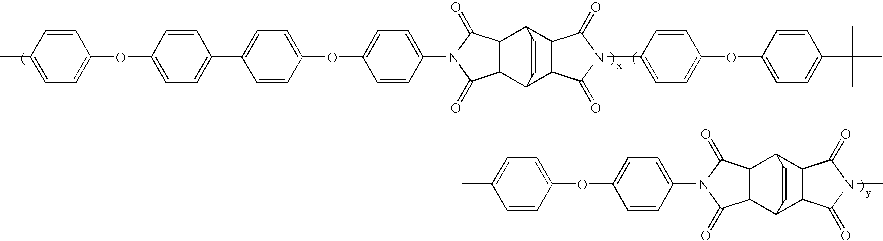

3.05 g BAPB (diamine) and 1.46 g BAPPm (diamine) were completely dissolved in 30 g cresol under nitrogen at room temperature. 3.0 g B1317 (dianhydride) was then added and continuously stirred for 3 hours after B1317 was completely dissolved to form a sticky PAA solution. Next, the PAA solution was thermally imidized (220° C.) for 3 hours to prepare PI-BAB (polyimide). The PI-BAB solution was then coated on a glass. After removal of solvent in an oven, a transparent and colorless polyimide film was prepared. The thickness, in-plane retardation (R0) and thickness direction retardation (Rth) thereof were then measured and recited as in Table 1.

### EXAMPLE 2

### Extension of Polyimide Film (1)

The 30 μm PI-BAB film was extended by a single-axis extension machine. The extension temperature was 210° C. The extension ratio was 1.1 (10%). The thickness, in-plane retardation (R0) and thickness direction retardation (Rth) thereof were then measured and recited as in Table 1.

### EXAMPLE 3

### Extension of Polyimide Film (2)

The 30 μm PI-BAB film was extended by a single-axis extension machine. The extension temperature was 210° C. The extension ratio was 1.2 (20%). The thickness, in-plane retardation (R0) and thickness direction retardation (Rth) thereof were then measured and recited as in Table 1.

TABLE 1

| | Thickness (μm) | R0 (nm) | Rth (nm) |
|---|---|---|---|
| PI-BAB | 34 | 0 | 671 |
| PI-BAB | 32 | 130 | 652 |
| (10%) | | | |
| PI-BAB | 29 | 448 | 850 |
| (20%) | | | |

Table 1 indicates that the extended PI-BAB optical compensation film has both, in-plane retardation (R0) and thickness direction retardation (Rth).

While the invention has been described by way of example and in terms of preferred embodiment, it is to be understood that the invention is not limited thereto. To the contrary, it is intended to cover various modifications and similar arrangements (as would be apparent to those skilled in the art). Therefore, the scope of the appended claims should be accorded the broadest interpretation so as to encompass all such modifications and similar arrangements.

What is claimed is:

1. A polyimide optical compensation film having formula: 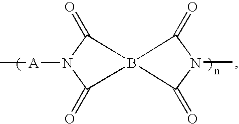
wherein when A is cycloaliphatic, B is aromatic or cycloaliphatic, when A is aromatic, B is cycloaliphatic, n is an integer greater than 1, and the optical compensation film has in-plane retardation (R0) and thickness direction retardation (Rth).

2. The polyimide optical compensation film as claimed in claim 1, wherein A comprises

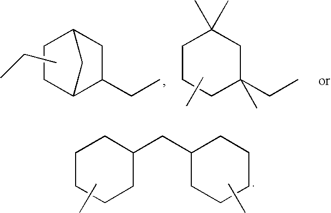

3. The polyimide optical compensation film as claimed in claim 2, wherein B comprises 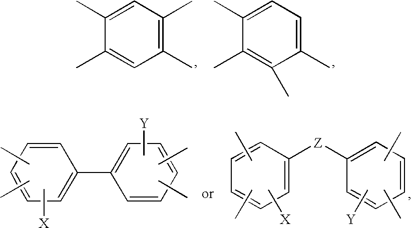
wherein X and Y comprise —H, —CH₃, —CF₃, —OH, —OR, —Br, —Cl or —I, and Z comprises —O—, —CH₂—, —C(CH₃)₂—, —Ar—O—Ar—, —Ar—CH₂—Ar—, —O—Ar—C(CH₃)₂—Ar—O—, —O—Ar—Ar—O—, —O—Ar—C(CF₃)₂—Ar—O— or —Ar—C(CH₃)₂—Ar—.

4. The polyimide optical compensation film as claimed in claim 2, wherein B comprises

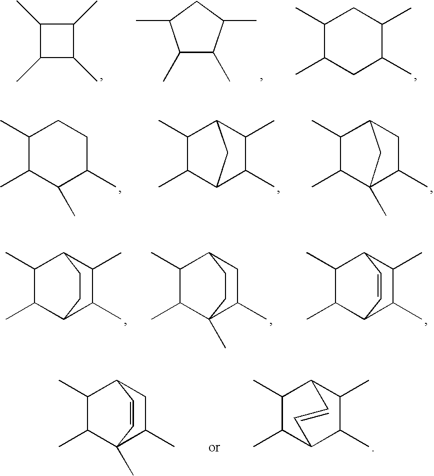

5. The polyimide optical compensation film as claimed in claim 1, wherein A comprises 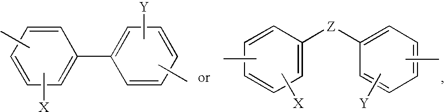
wherein X and Y comprise —H, —CH₃, —CF₃, —OH, —OR, —Br, —Cl or —I, and Z comprises —O—, —CH₂—, —C(CH₃)₂—, —Ar—O—Ar‘, —Ar—CH₂—Ar—, —O—Ar—C(CH₃)₂—Ar—O—, —Ar—O—Ar—C(CH₃)₂—Ar—O—Ar—, —O—Ar—Ar—O—, —O—Ar—C(CF₃)₂—Ar—O— or —Ar—C(CH₃)₂—Ar—.

6. The polyimide optical compensation film as claimed in claim 5, wherein B comprises

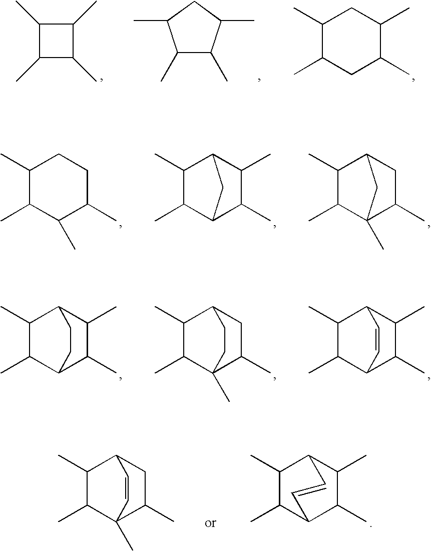

7. The polyimide optical compensation film as claimed in claim 1, wherein the optical compensation film has the in-plane retardation (R0) of about 20-450 nm.

8. The polyimide optical compensation film as claimed in claim 1, wherein the optical compensation film has the thickness direction retardation. (Rth) of about 40-900 nm.

9. The polyimide optical compensation film as claimed in claim 1, wherein the polyimide optical compensation film has thickness of about 5-30 μm.
